(19) United States
(12) Patent Application Publication
(10) Pub. No.: US 2016/0085738 A1
(43) Pub. Date: Mar. 24, 2016

(54) Cloud-Based Parallel Computation Using Actor Modules

(71) Applicant: Microsoft Technology Licensing, LLC, Redmond, WA (US)

(72) Inventor: Barry L. Briggs, Mercer Island, WA (US)

(21) Appl. No.: 14/495,850

(22) Filed: Sep. 24, 2014

(51) Int. Cl. G06F 17/24; G06F 3/0484; G06F 3/0482

(52) U.S. Cl. CPC G06F 17/246; G06F 3/0482; G06F 3/04842

(57) ABSTRACT

A cloud-based computing system is described herein for executing an application using an actor model programming paradigm. The computing system provides plural actor modules that correspond to activated instantiations of at least one actor module type. In one implementation, at least a subset of the actor modules have counterpart user interface (UI) interaction units, presented via a client-side application module, through which an end user may interact with the subset of the plural actor modules. The computing system also includes functionality for parallelizing computations performed by an actor module, receiving input information from external sources, associating an aggregate item (having plural entry items) with a single actor module, and so on.

### BACKGROUND

Developers have traditionally created end-user applications for execution on standalone user computing devices. Common end-user applications include spreadsheet applications, dedicated accounting applications, forms-based applications, and so on. Some developers have begun to write applications which leverage remote computing resources. However, these applications may otherwise use the same programming paradigms as applications which run on standalone user computing devices. In other words, a developer may move an application to the “cloud” by deploying the standalone application code on one or more server computing devices, hosted by a data center.

### SUMMARY

A cloud-based computing system is described herein for executing an application using a plurality of actor modules, based on an actor model programming paradigm. In one implementation, at least some of the actor modules have counterpart user interface (UI) interaction units, presented via a client-side application module. An end user may interact with those actor modules via the UI interaction units.

For example, in a spreadsheet-based application, the actor modules may encapsulate the behavior and state of respective cells within a spreadsheet. The user may interact with the actor modules via UI interaction units provided by a client-side application module. From the end user's perspective, those UI interaction units may resemble the cells in a traditional spreadsheet; however, in one implementation, the client-side application module serves mainly as a conduit of information flowing to and from the actor modules provided by the cloud-based computing system, which perform the work associated with the respective cells in the spreadsheet.

The cloud-based computing system may also include a variety of additional features, such as: functionality for feeding plural input information items into a particular actor module in a parallel fashion; functionality for receiving input information items from external sources of information; functionality for loading aggregate items, composed of plural entry items, into a single actor module, and so on.

Also described herein are various applications that leverage the functionality of the cloud-based computing system.

The above approach can be manifested in various types of systems, devices, components, methods, computer readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of an environment for executing an application using a cloud-based computing system; the cloud-based computing system, in turn, employs an actor model programming paradigm.

FIG. 2 shows computing resources that can be used to implement the cloud-based computing system of FIG. 1.

FIG. 3 shows additional illustrative detail regarding a distributed runtime environment, provided by the cloud-based computing system of FIG. 1.

FIG. 4 shows additional details regarding the distributed runtime environment of FIG. 3.

FIG. 5 shows one implementation of a client-side application module. An end user uses the client-side application module to interact with the computing system of FIG. 1.

FIG. 6 shows one implementation of a particular actor module, corresponding to an activated instantiation of a particular actor module type.

FIG. 7 shows functions performed by an interpretation module and an operation execution module, which are two components of the particular actor module of FIG. 6.

FIGS. 8 and 9 show additional functions performed by the operation execution module, provided by the actor module of FIG. 6.

FIG. 10 depicts the application of the computing system (of FIG. 1) to the implementation of a single-user forms-based application.

FIG. 11 depicts the application of the computing system (of FIG. 1) to the implementation of a multi-user forms-based application.

FIG. 12 depicts the use of the computer system (of FIG. 1) to process plural streams of information items supplied by plural respective external information sources.

FIG. 13 depicts a multi-dimensional actor space for organizing actor modules, within a cloud-based application module.

FIG. 14 shows a process which represents one manner of operation of an illustrative actor module, within the computing system of FIG. 1.

FIG. 15 shows a process which represents one manner by which an actor module may parallelize the manner in which it receives input information items from plural predecessor actor modules.

FIG. 16 shows illustrative computing functionality that can be used to implement any aspect of the features shown in the foregoing drawings.

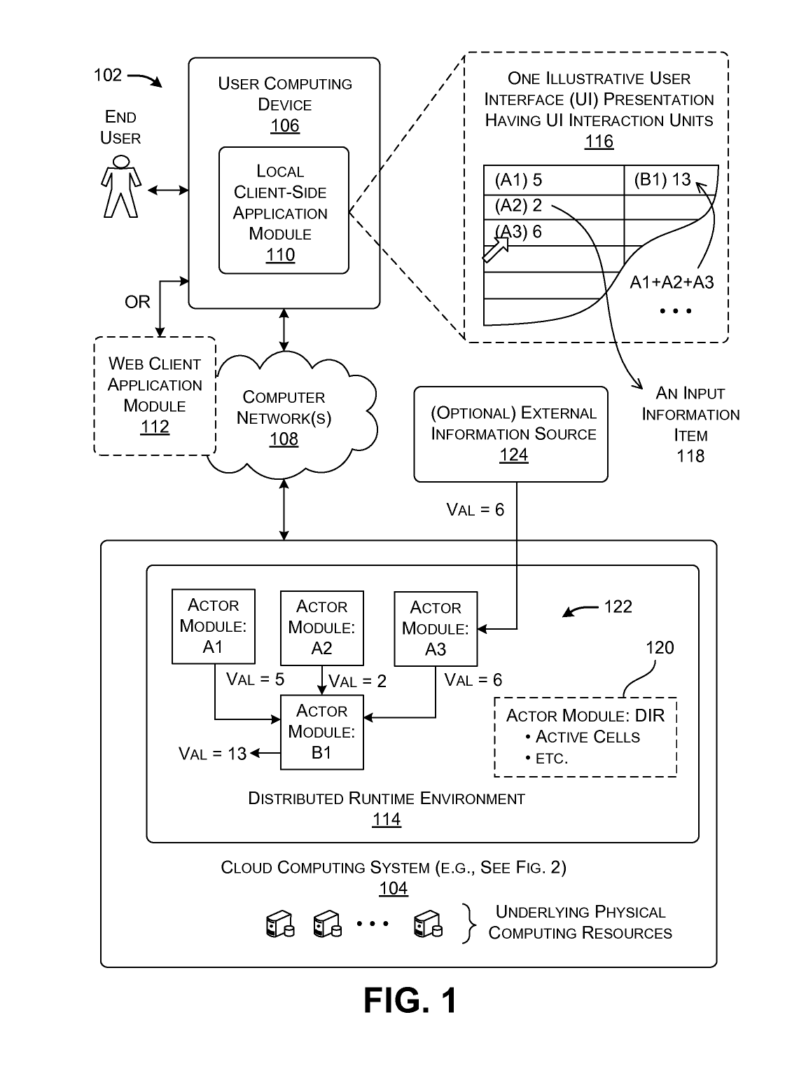

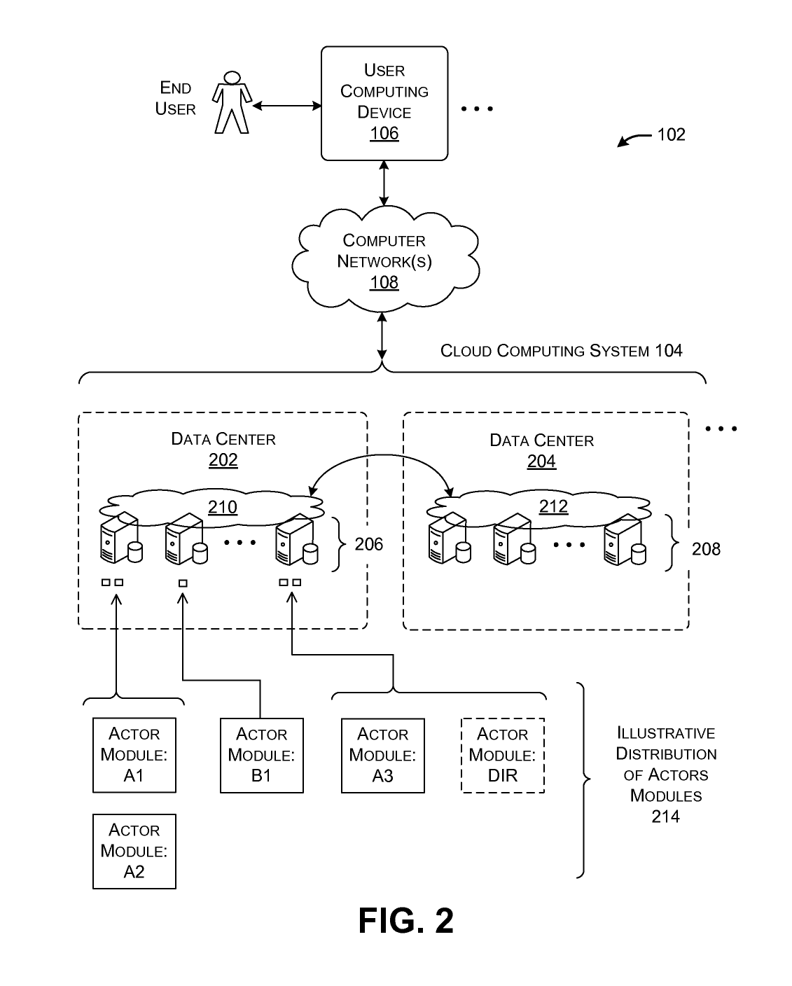

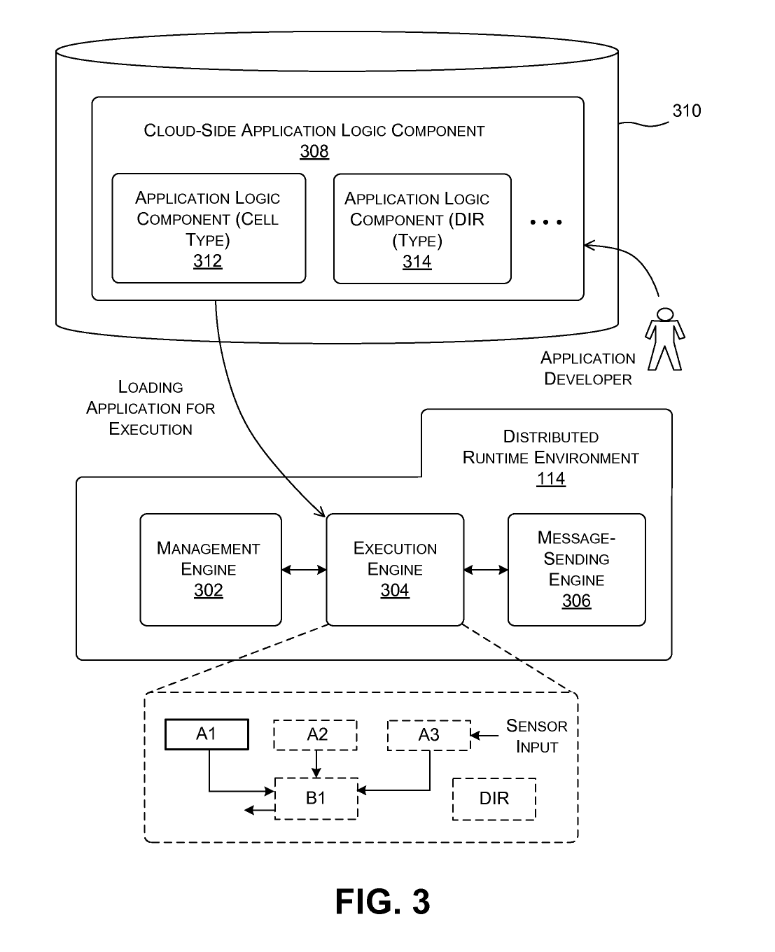

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative environment for executing an application using a cloud-based computing system. Section B sets forth illustrative methods which explain the operation of the environment of Section A. Section C describes illustrative computing functionality that can be used to implement any aspect of the features described in Sections A and B.

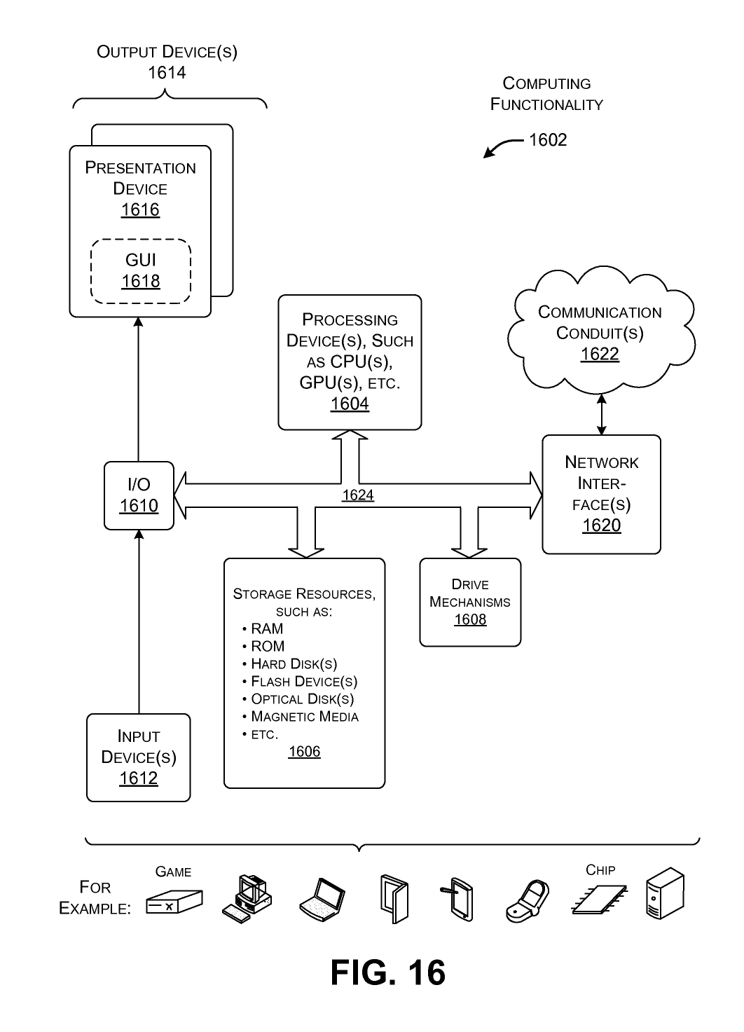

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software running on computer equipment, dedicated hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 16, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software running on computer equipment, dedicated hardware (e.g., chip-implemented logic functionality), etc., and/or any combination thereof.

As to terminology, the phrase “configured to” encompasses any way that any kind of physical and tangible functionality can be constructed to perform an identified operation. The functionality can be configured to perform an operation using, for instance, software running on computer equipment, dedicated hardware (e.g., chip-implemented logic functionality), etc., and/or any combination thereof.

The term “logic” encompasses any physical and tangible functionality for performing a task. For instance, each operation illustrated in the flowcharts corresponds to a logic component for performing that operation. An operation can be performed using, for instance, software running on computer equipment, dedicated hardware (e.g., chip-implemented logic functionality), etc., and/or any combination thereof. When implemented by computing equipment, a logic component represents an electrical component that is a physical part of the computing system, in whatever manner implemented.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative Environment for Performing Cloud-Based Computations

A.1. Overview

FIG. 1 shows an environment 102 that includes a cloud-based computing system 104 (henceforth, simply “computing system” 104). Users may interact with the computing system 104 via respective user computing devices to execute one or more applications of any type(s). FIG. 1, for instance, shows that a representative end user uses a computing device 106 to execute a spreadsheet-type application.

The computing system 104 may be physically implemented by one or more server computing devices, provided at a single site or distributed over plural sites. FIG. 2, described below, provides additional information regarding one implementation of the computing system 104. The user computing device 106 can correspond to, for example, a workstation-type personal computing device, a laptop computing device, a game console device, a set-top box device, a tablet-type computing device, a smartphone, a wearable computing device, and so on.

One or more computer networks 108 may allow the user computing device 106 to interact with the computing system 104. The computer network(s) 108 may correspond to a local area network, a wide area network (e.g., the Internet), point-to-point links, or any combination thereof.

By way of introductory terminology, the term “application logic component” refers to the code (or other manifestation of logic) that implements an application function. The term “application module” refers to a runtime instantiation of an application logic component, provided by a runtime execution environment, and stored in physical memory.

The environment 102 may implement an application using a client application module and a counterpart cloud-side application module. That is, the client application module and the counterpart cloud-side application module cooperate to execute the functions of the application. In one case, the user computing device 106 may provide the client application module, e.g., corresponding to a local client-side application module 110. In another case, one or more remote server computing devices may provide the client application module, e.g., corresponding to a web client application module 112. In another case, the client application module can be distributed between local and remote resources. On the other hand, the computing system 104 may provide the cloud-side application module.

In one implementation, the client application modules (110, 112) provide a “dumb” front end by which the end user may interact with the application, whereas the cloud-side application module performs the core of the functions associated with the application. In other words, the client application modules (110, 112) serve primarily as conduits to receive input information from the end user and to provide output information to the end user.

The cloud-side application module may implement its functions using the resources provided by an actor model programming paradigm. An actor model programming paradigm refers to a programming model that expresses the behavior of an application using plural actor modules. The actor modules perform defined processing task during runtime, and capture their respective local states. But the actor entities are isolated and independent entities that do not share memory. They cooperate via the exchange of messages, rather than (or in addition to) connections and relationships established by an overarching application program (as is the case for more traditional programming models).

More specifically, in one implementation, the cloud computing system 104 can leverage the management resources of a commercially available actor model platform, such as the publically-available ORLEANS framework provided by Microsoft Corporation of Redmond, Wash. Other actor-based frameworks include the ERLANG programming framework developed by Telefonaktiebolaget L. M. Ericsson, of Kista, Stockholm, Sweden, and the AKKA programming framework developed by Typesafe Inc., of San Francisco, Calif. In another implementation, the cloud computing system 104 can use the management resources of a custom-developed actor model framework.

To be more explicit, an actor model framework provides underlying resources for managing units of work in the context of actor modules. But the framework itself does not dictate the manner in which any application is to be expressed in the context of plural actor modules; nor does it define the makeup and functionality associated with individual actor modules. Rather, it is the task of the application developer to determine: whether a particular application is a good candidate to express using the actor model programming paradigm; and, if so, how to express the application functions using plural actor modules.

The environment 102 of FIG. 1 represents one solution to the above technical challenges. To appreciate the nature of the solution, first consider the specific example summarized in FIG. 1. In that example, the application implements spreadsheet functionality. The spreadsheet functionality allows the user to enter values and formulas into the discrete cells of a spreadsheet. The spreadsheet functionality executes a formula associated with a particular cell when a change is made to the spreadsheet which directly or indirectly affects that cell.

More specifically, the local client-side application module 110 (or the web client application module 112) provides a user interface (UI) presentation 116 to the user. The UI presentation 116 includes a grid of cells that make up one page of a spreadsheet. The end user may enter a value or formula (or other information) into any cell. For example, the user has entered the values 5 and 2 into the cells having addresses A1 and A2, respectively. The cell having the address A3 has a value of 6, which is supplied by an external information source (in a manner to be described below). The user has then entered a formula into the cell having the address B1; that formula specifies that the value to appear in that cell will correspond to the sum of the values in the cells having addresses A1, A2, and A3.

More generally, a cell is a specific example of any control mechanism through which the user may interact with the client-side application module 110. That control mechanism is more generally referred to below as a user interface (UI) interaction unit. For example, in another scenario, a forms-based application may present a UI presentation having boxes or fields for entering information and/or displaying calculated output results. Each box or field may be considered as an UI interaction unit.

Further, the following explanation refers to any information entered into a UI interface unit as an “input information item.” For example, in FIG. 1, the value of 2 entered in the cell address A2 corresponds to one input information item 118. In another case, an input information item may correspond to a formula, etc. To also facilitate explanation, a UI interaction unit (e.g., a cell) having a particular address is identified by that address; for example, the cell having the address A2 is referred to below as “cell A2.”

The distributed runtime environment 114 instantiates actor modules associated with the UI interaction units as the UI interaction units are used by the end user. For instance, the distributed runtime environment 114 instantiates an actor module for each UI interaction unit that receives an input information item, or which receives an output information item. In the context of FIG. 1, at runtime, the distributed runtime environment 114 produces actor modules A1-A3 that correspond to cells A1-A3, and actor module B1 that corresponds to cell B1. The distributed runtime environment 114 may also optionally create a directory actor module 120, to be described in greater detail below. Collectively, the actor modules produced by the distributed runtime environment 114, at any given time, constitute a cloud-side application module 122.

Each actor module may perform any behaviors encompassed by an underlying actor module type. Further, each actor module may perform those behaviors from the “vantage point” of a particular aspect of the application that is being run. For example, an actor module that represents a particular UI information unit (e.g., a particular cell) in a spreadsheet may perform functions that affect whatever information is presented in that UI information unit. For example, the functions can allow the actor module to execute a formula associated with the actor module, and/or to communicate with other, communicatively linked, actor modules in the spreadsheet. Another actor module can perform the same functions from its own “perspective” within the spreadsheet application. The optional directory actor module 120 may, among other functions, provide a list of actor modules that have been instantiated (activated) at any given time.

One or more of the actor modules may also receive input information items from other sources, that is, rather than from receiving input from the end user in manual fashion. For example, the actor module A3 receives an input information item from an external information source 124. The external information source 124 may represent any supply of information. For example, in one case, the external information source 124 may correspond to a sensor device which provides measurement readings. For instance, the sensor device may correspond to a temperature sensor which provides temperature readings. In another case, the external information source 124 may correspond to a web site that provides information of any nature. For instance, the web site may correspond to a social network application which provides messages or metadata pertaining to identified individuals, or a financial application which provides stock price information, etc. In another case, external information source 124 may correspond to an appliance or other type of device. That appliance or other device may supply information that pertains to its state, etc. The above examples are provided in the spirit of illustration, not limitation; the computing system 104 can receive input information items from any source(s) that are hosted at any site(s) and administered by any entity(ies).

In another example (not shown), an actor module may receive what is referred to herein an “aggregate item.” The aggregate item corresponds to a body of information that encompasses plural entry items, such as a file that encompasses multiple temperature readings, etc. The actor module may load and parse the aggregate item, and thereafter represent the collection of entry items as a single entity of information. Such an actor module is also referred to herein as a super cell. Other actor modules may retrieve individual entry items from the super cell by specifying address information which identifies those entry items within the super cell.

In another example, at least one actor module can be used to supply an output information item to some target destination other than the UI presentation 116. For example, at least one actor module can be used to send an output information item to a device, e.g., for use in controlling the device in any manner. More generally, different actor modules can be assigned to the task of controlling different devices.

Advancing to FIG. 2, this figure shows one physical implementation of the computing system 104 of FIG. 1. The computing system 104 may include one or more data centers (e.g., data centers 202, 204, . . . ). Each data center can include one or more server computing devices and/or other data processing equipment (e.g., load balancers, routers, etc.). For example, the data center 202 includes one or more server computing devices 206, while the data center 204 includes one or more server computing devices 208. Each data center may use any internal network to couple together its computing resources. For example, the data center 202 uses a local network 210, while the data center 204 uses a local network 212. One such type of network that can be used organizes the server computing devices into a series of racks; the server computing devices within the racks may exchange information with other server computing devices using a hierarchical topology of switches, e.g., using a fat tree topology.

The distributed runtime environment 114 (of FIG. 1) is said to be distributed because its functionality is spread over the physical computing resources of the computing system 104. For example, each server computing device in the computing system may implement an instantiation of the resources of the distributed runtime environment 114. Additional details regarding one implementation of the distributed runtime environment 114 are provided below in the next subsection (i.e., Subsection A.2).

The distributed runtime environment 114 also distributes the actor modules 214 that implement the cloud-side application module 122 across one or more physical server computing devices (e.g., 206, 208). In one merely representative case, for instance, the distributed runtime environment 114 may allocate the actor modules A1 and A2 to a first server computing device, the actor module B1 to another server computing device, and the actor modules A3 and “DIR” (implementing the directory functionality) to another server computing device, and so on. Thus, in this example, the distributed runtime environment 114 distributes the components of the cloud-side application module 122 across the devices of a single data center 202. But in other examples, the distributed runtime environment 114 may allocate the actor modules across two or more data centers. In still other examples, the distributed runtime environment 114 may allocate the actor modules to a single server computing device.

As will be described more fully in Subsection A.2 (below), the distributed runtime environment 114 can take into consideration one or more factors in deciding how to allocate the actor modules to different computing devices. Those considerations may include any of: workload-based considerations, failure-related considerations, latency-related considerations, reliability-related considerations, and so on. In any event, the distributed runtime environment 114 allocates actor modules in a manner that is transparent to the end user, meaning that the end user is typically not aware of “where” the actor modules are being physically executed. Furthermore, the application developer is not tasked with the responsibility of managing the allocation of actor modules within his or her application code; the distributed runtime environment 114 automatically carries out those functions as a background service.

In summary to this introductory subsection, the environment 102 provides a computing system 104 that is made up of plural computing devices, provided by one or more data centers. The plural computing devices have computing resources that host plural actor modules. The plural actor modules correspond to activated instantiations of at least one actor module type in an actor model programming paradigm. Further, the plural actor modules are coupled together, via an exchange of messages, according to a defined graph relationship. Further, at least a subset of the plural actor modules may have counterpart UI interaction units (e.g., cells or fields in a form), presented via a client-side application module. An end user may interact with the actor modules through those UI interaction units.

The environment 102 provides the illustrative benefit of more efficiently executing application functions, that is, compared to traditional standalone client applications. The above advantage stems, in part, from the parallel nature of the computations performed by the computing system 102. For example, each actor module works in an independent manner from other actor modules, and therefore may work in parallel with the work performed by the other actor modules. It is true that a particular actor module may need to collect input information items from its predecessor actor modules (as defined by a graph relationship) in order to perform a computation; however, that particular actor module can receive the input information items from its predecessors in parallel, greatly expediting its overall computation operation. This advantage is particularly pronounced when the particular actor module receives input information items from a large number of predecessor actor modules.

In addition, the computing system 104 offers much more computing resources compared to a traditional standalone user computing device. These computing resources include processing and memory resources. The environment 102 can leverage this characteristic, together with the above-described parallelism characteristics, to execute new applications that would not be feasible in a standalone client application context.

A.2. Illustrative Distributed Runtime Environment

FIG. 3 shows an overview of one implementation of the distributed runtime environment 114, introduced in the context of FIG. 1. More specifically, FIG. 3 shows a single instantiation of the distributed runtime environment 114 that may be deployed on a single server computing device. Other server computing devices (not shown) may implement the same functionality shown in FIG. 3.

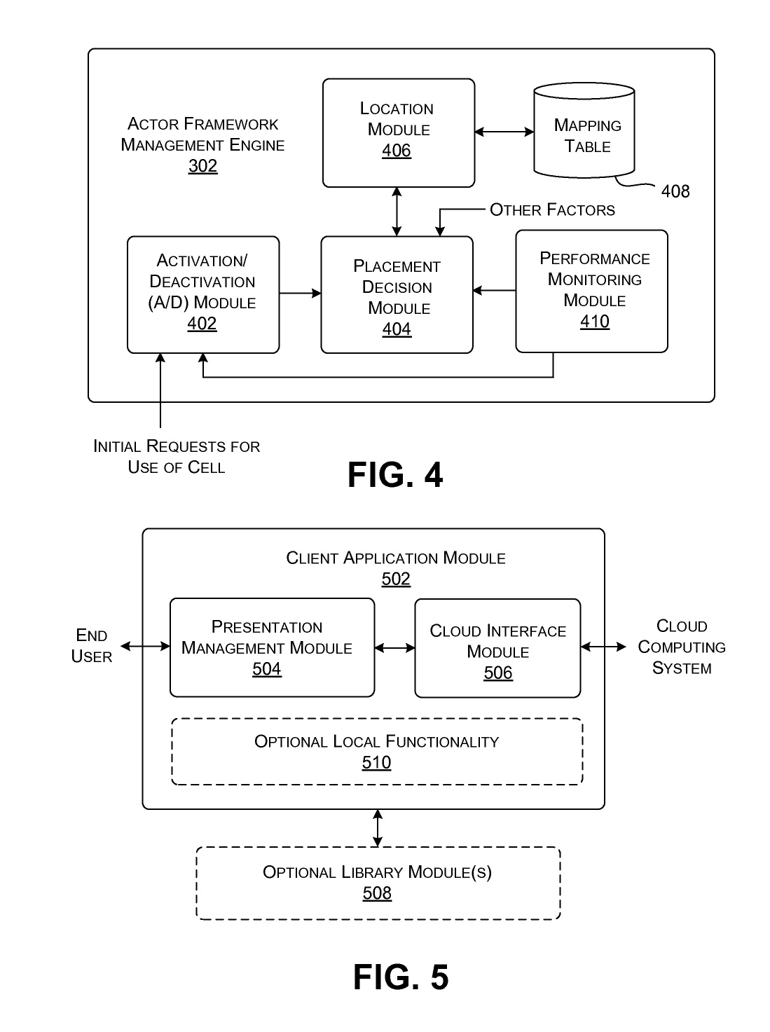

The distributed runtime environment 114 may include three functional components: a management engine 302, an execution engine 304, and a message-sending engine 306, or other mechanisms which performs the equivalent functions. The management engine 302 performs a number of functions to be described in detail in the context of FIG. 4 (below). As one of those functions, the management engine 302 can instantiate an actor module in memory when that actor module is needed in the implementation of the application. For example, the management engine 302 can automatically instantiate the actor module A1 when the end user enters an input information item into a corresponding UI interaction unit of the UI presentation 116.

The management engine 302 may create an instance of an actor module by creating an in-memory instantiation of a particular actor module type. More specifically, the computing system 104 may store a cloud-side application logic component 308 in one or more data stores 310. The cloud-side application logic component 308, in turn, can include plural subcomponents (e.g., classes) which implement different types of actor modules, such as an application logic component 312 for a cell-based actor module, an application logic component 314 for a directory actor module, and so on. To produce an actor module associated with a particular UI interaction unit (e.g., a particular cell), the distributed runtime environment 114 can create an in-memory copy of the application logic component 312. To produce the directory actor module 120, the distributed runtime environment 114 can create an in-memory copy of the application logic component 314, and so on. Other implementations of the computing system 104 may accommodate additional actor module types. Each application logic component in the data store 310 can be expressed in any programming language (such as C#), and may utilize the library resources of any programming platform, such as the .NET 4.5 Framework provided by Microsoft Corporation of Redmond, Wash.

The execution engine 304 carries out the operations of the functions in an instantiated actor module. The message-sending engine 306 transfers messages among actor modules. More specifically, as to the message-passing functionality, an actor module may send a message to another actor module by invoking an appropriate method call. The message-sending engine 306 can serialize the arguments associated with the method call into a message, and then send the message to the appropriate recipient actor module, e.g., via Transmission Control Protocol (TCP) and/or any other transmission protocol. The instance of the message-sending engine that is available to the other actor module can then de-serialize the arguments and pass them to the other (recipient) actor module. (Additional information on serializing/de-serializing is provided below.)

Advancing to FIG. 4, this figure shows further illustrative details of the management engine 302 provided by the distributed runtime environment 114. The management engine 302 includes a number of components that perform different respective functions. To begin with, assume that an end user loads a particular client application module, such as the spreadsheet application shown in FIG. 1. In response, an activation/deactivation (A/D) module 402 activates actor modules associated with the application over the course of the user's interaction with that application. The A/D also controls the manner in which the actor modules are deactivated.

More specifically, the A/D module 402 may activate an actor module only at that stage in which that actor module's services are required. For example, as previously stated, the A/D module 402 may create an actor module for the UI interaction unit A1 only when a user enters a value (or formula) into that UI interaction unit.

The A/D module 402 may also assign a reference item to an actor module that has been crated. The particular actor module is henceforth referred to by any entity within the cloud-side application module 122 by specifying its reference item. For example, another actor module may send a message to the particular actor module by specifying the reference item of that particular actor module.

The A/D module 402 places the newly created actor module in the memory of a particular server computing device. To perform this task, the A/D module 402 receives a placement decision from a placement decision module 404. The placement decision module 404 can use different strategies in deciding where to place a new actor module. In one strategy, the placement decision module 404 can randomly choose a server computing device to host the new actor module. In other strategy, the placement decision module 404 can choose the server computing device based on a round-robin selection scheme, and so on.

In other cases, the placement decision module 404 can take into consideration one or more factors in determining where to deploy the actor module, including any of: load balancing considerations, reliability considerations, device-failure considerations, latency-related considerations, etc. With respect to load balancing considerations, the placement decision module 404 may attempt to spread active actor modules over plural server computing devices so as to not overwhelm the workload capacity of any one server computing device. With respect to reliability considerations, the placement decision module 404 may spread the actor modules over plural server computing devices to mitigate the disturbance caused by the failure of any individual server computing devices. With respect to device-failure considerations, the placement decision module 404 may attempt to spread the actor modules over those devices that are currently offering the most error-free performance, or may attempt to at least avoid those server computing devices that are offering markedly inferior performance. With respect to latency-related considerations, the placement decision module 404 may attempt to place actor modules on server computing devices to minimize the communication cost of exchanging messages between actor modules.

The above considerations are cited above in the spirit of illustration, not limitation. Further note that there may be tension between different considerations. For example, the load-balancing considerations and the reliability considerations may weigh in favor of a strategy of widely distributing the actor modules, while the latency considerations may weigh in favor of a strategy of more narrowly distributing the actor modules. The placement decision module 404 can make its choice based on any environment-specific rules; these rules have the effect of establishing the relative importance of different considerations in different respective scenarios.

A location module 406 identifies the physical location of an actor module after it has been placed on a particular server computing device. More specifically, the application treats each actor module as a virtual entity, and is agnostic with respect to the details of the physical manifestation of the actor module, including the location at which it is stored within the computing system 104. The application accordingly makes reference to each actor module in a high-level abstract manner, e.g., by specifying its reference item, rather than its physical storage address. As a background service, the location module 406 maps the virtual identity (e.g., the reference item) of an actor module to an indication of the physical location where that actor module is stored in physical memory.

To perform the above mapping function, the location module 406 may consult a mapping table provided in one or more data stores 408. In one case, the mapping table identifies the physical locations for all of the activated actor modules, at any given time, e.g., by mapping the virtual addresses of these actor modules to the corresponding physical addresses of these modules. In that case, each server computing device that hosts the distributed runtime environment 114 may store a copy of the full mapping table.

In other cases, the distributed runtime environment 114 may use any partitioning technique to break the full mapping table into separate subsets (or partitions), and then allocate those partitions to different respective server computing devices. To perform a lookup operation, the distributed runtime environment 114 can first locate the partition which contains the physical address of the actor module under consideration, e.g., by hashing identification information associated with the actor module, which yields information which identifies the partition. The distributed runtime environment 114 can then interact with the identified partition to look up the location in memory where the actor module under consideration can be found.

The A/D module 402 can also deactivate an active actor module for different reasons. For example, the A/D module 402 can deactivate an active actor module when it has not been used for a prescribed amount of time, and is therefore presumed to be no longer needed. In another case, the A/D module 402 can deactivate an active actor module in the course of migrating the actor module from a first server computing device to a second server computing device. The distributed runtime environment 114, in turn, may decide to migrate an actor module for any number of reasons, e.g., to balance the workload associated with an application, or in response to an experienced or predicted failure of the first server computing device, etc. Note that the A/D module 402 does not necessarily deactivate an actor module in response to any user action, such as the user's deletion of a cell value or formula associated with the actor module, or even the user's termination of the entire application.

A performance monitoring module 410 monitors the performance of each server computing device in any manner, to provide performance information. The placement decision module 404 can rely on the performance information as one factor in its determination of where to place an actor module under consideration. Similarly, the A/D module 402 can rely on the performance information as one factor in determining whether to deactivate an actor module.

From a higher level perspective, note that the distributed runtime environment 114 handles the tasks of activating and deactivating actor modules as background functions. As such, the application developer need not write code that explicitly performs these tasks. This characteristic simplifies the task of creating an application. For example, to once again reiterate, the distributed runtime environment 114 automatically creates actor modules on as as-needed basis, as a by-product of requests to use these actor modules. The distributed runtime environment 114 removes the actor modules from memory based on various system-level considerations, not necessarily linked to actions performed by the user, or the behavior of the application itself.

Note that a server computing device may experience a partial or complete failure, resulting in the loss of actor modules and mapping table information that are stored on that server computing device (if any). The distributed runtime environment 114 heals itself from this condition by first observing a failure to access the affected actor modules and mapping information. In response, the distributed runtime environment 114 will automatically create new copies of the affected actor modules and mapping information on non-failed server computing devices.

In certain implementations, the distributed runtime environment 114 can also create two or more redundant copies of the same actor module. For instance, the distributed runtime environment 114 can create two or more copies of the actor module A1 shown in FIG. 1. The distributed runtime environment 114 may dynamically create plural copies in this manner to reduce the workload experienced on any individual actor module, if that workload is assessed as sufficiently heavy. However, to facilitate and simplify the following explanation, it will be assumed that the distributed runtime environment 114 does not create duplicates of any individual active actor modules.

A.3. Illustrative Client-Side Application

FIG. 5 shows one implementation a client application module 502. In one case, the client application module 502 may correspond to functionality that is provided on a local computing device, such as, in FIG. 1, the local client-side application module 110 that is hosted by the user computing device 106. In another case, the client application module 502 may correspond to remotely implemented functionality, such as the web client application module 112 that is hosted on one or more server computing devices (where those server devices may be separate from the computing system 104). In still another case, the client application module 502 may provide functionality that is distributed between the local user computing device 106 and the remote server computing devices.

In one implementation, the client application module 502 functions primarily as an information-passing conduit. That is, the client application module 502 may collect input information items from the user, and supply output information items to the user. But the client application module 502 does not otherwise implement the functions which generate the output information items provided to the user. Rather, those functions are performed by the counterpart cloud-side application module, such as the cloud-side application module 122 of FIG. 1.

In the above implementation, a presentation management module 504 may present one or more user interface presentations to the user, such as the user interface presentation 116 shown in FIG. 1. The presentation management module 504 controls the appearance and behavior of those user interface presentations. In particular, the presentation management module 504 includes functionality for receiving input information items via the user interface presentation(s), and for conveying output information items via the user interface presentation(s).

An interface module 506 functions as an interface between the client application module 502 and the counterpart cloud-side application module. For example, the interface module 506 can formulate each input information item received via the presentation management module 504 into a message, and then send that message to the computing system 104. Similarly, the interface module 506 can extract an output information item from a message sent by the computing system 104, and present that output information item to the presentation management module 504 for presentation to the user. The interface module 506 may optionally rely on functionality provided by one or more library modules 508 in performing the above interface functions.

In another implementation, the client application module 502 can include local functionality 510 that performs other functions in addition to the above-described information-passing and information-presenting functions. For example, consider a spreadsheet application. In that context, the local functionality 510 can perform some or all of the same functions as any traditional spreadsheet application. In addition, the client application module 502 can interact with the computing system 104 to perform cloud-based operations. For example, in that implementation, the interface module 506 may correspond to an “add-on” interface module which allows the client application module 502 to interact with the computing system 104.

In a first hybrid mode of operation, the client application module 502 can give the user the option of implementing all spreadsheet application tasks using either the traditional local functionality 510 or the cloud-based application module, but not both. In a second hybrid mode, the client application module 502 can implement some cells of the spreadsheet application using the local traditional local functionality 510, and can implement other cells of the spreadsheet using the cloud-side application module. In a third hybrid mode, the client application module 502 can implement at least some cells of the spreadsheet application using the traditional local functionality 510. The user can then export the cells created in this traditional process to the computer system 104. The computer system 104 can then generate actor modules associated with the cells, within the actor model programming paradigm. The opposite operation can also be performed. For instance, the user can instruct the computer system 104 to download information regarding its actor modules to the client application module 502; the client application module 502 then populates local counterpart cells using the local functionality 510. Still other hybrid solutions are possible for different types of applications.

In any event, the client application module 502 can be constructed based on any programming paradigm, not necessarily the above-described actor model programming paradigm. But in other implementations, both the client application module 502 and the cloud-side application module can perform their respective functions using the actor model programming paradigm.

A.4. Illustrative Actor Module

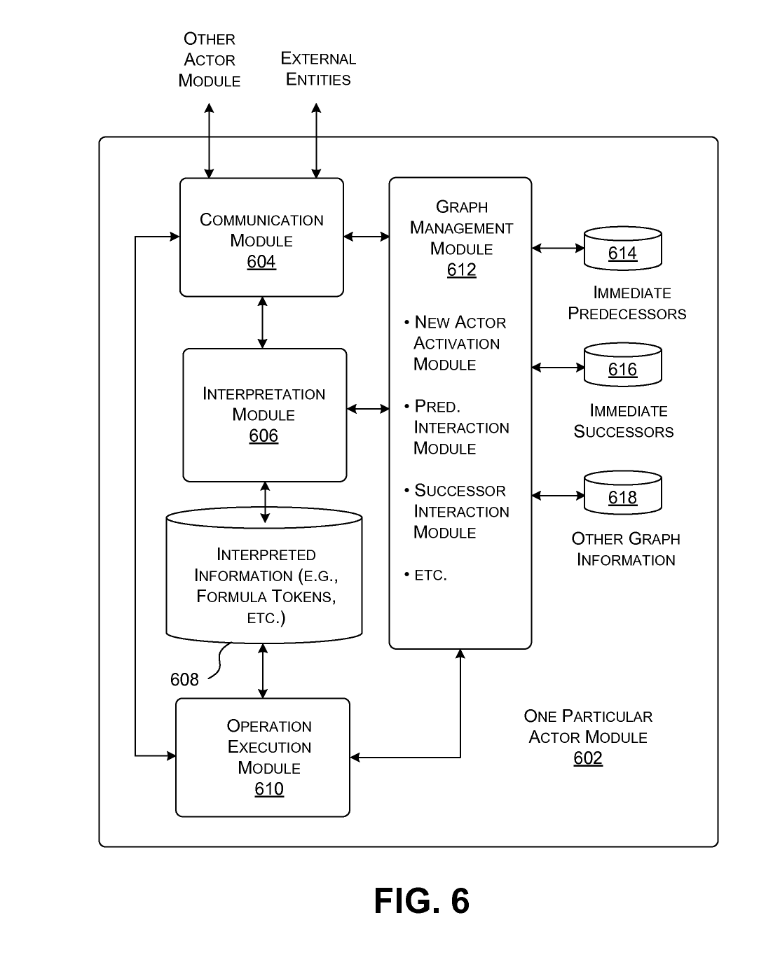

FIG. 6 shows one implementation of a particular actor model 602, representing a runtime instantiation a cell-based actor module. In other words, the actor module 602 corresponds to the type of actor module that performs functions that affect a particular UI interaction unit (e.g., a cell) within an application (e.g., a spreadsheet application). Other actor modules of the same type can perform the same functions with respect to other respective UI interaction units. As described in Subsection A.2, the distributed runtime environment 114 creates the actor module 602 when the application has work for that actor module 602 to perform, and not before.

The actor module 602 is depicted and described as comprising a specific collection of components that perform respective functions. Such an implementation is described in the spirit of illustration, not limitation. For instance, in other cases, an application developer may allocate two or more different types of actor modules for handling different subsets of functions shown in FIG. 6.

To begin with, the actor module 602 includes a communication module 604. The communication module 604 may implement methods that can be invoked to receive messages from external entities (such as the local client-side application module 110 or the external information source 124 of FIG. 1) or from other actor modules. The communication module 604 can also implement methods that can be invoked to pass messages to external entities or other actor modules. For example, the methods may operate in a synchronous and/or asynchronous manner to send synchronous and/or asynchronous messages.

To perform its functions, the communication module 604 works in cooperation with the runtime environment's message-sending engine 306. The message-sending engine 306 performs the underlying mechanics of sending and receiving messages, such as by serializing arguments, forwarding messages, de-serializing arguments, and so on. Serializing refers to the act of converting information expressed in a first format into a second format, where the second format expresses the information as a linear stream (e.g., which is suitable for transfer, storage, etc.); de-serializing refers to the process of converting the information back to the first format.

An interpretation module 606 provides logic for interpreting whatever input information item has been received via the communication module 604, to provide interpretation information. For example, the interpretation module 606 interprets whatever value or formula or other information item has been entered into a client-side UI interaction unit (e.g., which, in turn, may correspond to a spreadsheet cell). When a formula is detected, the interpretation module 606 can employ any type of parser, such as a recursive-descent parser, to interpret the formula. Parsing generally involves examining the components (e.g., characters) of the input information item against a dictionary or grammar, to thereby determine the meaning of the components that have been input, as well as the meaning of the overall input information item.

The interpretation module 606 may then store the results of its analysis in a data store 608. The results are referred to herein as an interpretation, or as interpretation information. For example, in the case that a formula is detected, the interpretation module 606 may store formula tokens which represent the outcome of its analysis. The formula tokens establish the meaning of the components of the formula.

In one implementation, the interpretation module 606 may performs its parsing function and store the formula tokens upon first encountering a new formula. The interpretation module 606 may refrain from repeating its parsing operation when the same formula is encountered again, with respect to the particular actor module 602, unless that formula has been modified (in which case it may be considered as a new formula).

An operation execution module 610 performs an operation based on the interpretation information provided the interpretation module 606. For example, assume that the interpretation module 606 concludes that the input information item corresponds to a new formula. After the formula has been parsed by the interpretation module 606, the operation execution module 610 can execute the formula. Execution of the formula may comprise collecting input values from one or more predecessor actor modules (to be described below), generating an output result based on the formula tokens, and sending the output result to one or more successor actor modules (to be described below). The output result is also referred to herein as an output information item.

In addition, the operation execution module 610 can send the output information item to the client-side application module 110. The client-side application module 110 then displays the output information item in the UI interaction item (e.g., the cell) that corresponds to the particular actor module 602. For example, after the user enters the formula into the cell B1 in FIG. 1, the actor module that corresponds to the cell B1 can return a value 13 for display in that cell, which corresponds to the sum of the values in cells A1, A2, and A3. As noted above, the communication module 604 handles interaction with the client-side application module 110 and other actor modules by invoking appropriate method calls.

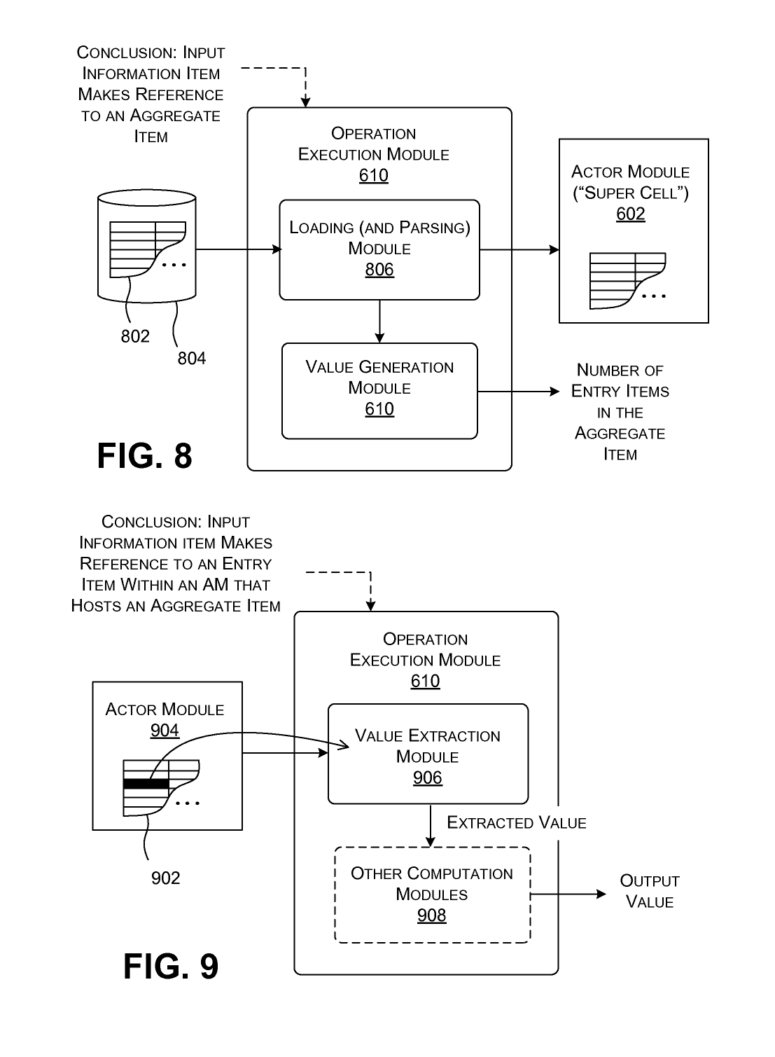

In other cases, the interpretation module 606 and the operation execution module 610 perform other respective functions, e.g., depending on the nature of the input information item that has been received. Examples of these additional functions will be described below, e.g., with reference to FIGS. 8 and 9.

A graph management module 612 performs various functions that support the operations described above. By way of introduction, the actor module 602 may have a value that depends on one or more immediate predecessor actor modules. In addition, or alternatively, the actor module 602 may have a value that influences the values in one or more immediate successor actor modules. Overall, the actor modules associated with a cloud-side application module may be conceptualized as a set of nodes within a graph. The links between the nodes represent dependencies among the actor modules. In the above context, the graph management module 612 performs functions that may make reference to, or depend on, the relationship between the particular actor module 602 and other linked actor modules in the graph.

For example, the graph management module 612 can perform various functions that may involve interaction between the actor module 602 and its predecessor actor module(s) and/or successor actor module(s), if any. For example, a user may enter a new formula into the UI interaction unit associated with the actor module 602. If this formula depends on the values of any predecessor actor modules, then the graph management module 612 can notify those predecessor actor modules of the dependency relationship that has been established by the new formula. Thereafter, the operation execution module 610 can work in cooperation with the graph management module 612 to collect input information items from these predecessor actor modules whenever the formula is evaluated or reevaluated. In connection therewith, a data store 614 may store a list of the predecessor actor modules associated with the particular actor module 602.

In a similar manner, the graph management module 612 can receive messages from one or more other actor modules, notifying it that the particular actor module 602 is a predecessor actor module with respect to those other actor modules. From the perspective of the particular actor module 602, those other actor modules constitute successor actor modules. Then, when an output result is generated for the particular actor module 602, the operation execution module 610 can work in cooperation with the graph management module 612 to forward that output result to the downstream successor actor modules. A data store 616 may store a list of the successor actor modules of the particular actor module 602.

In certain cases, the graph management module 612 can also initiate actions which cause the creation of a new actor module. For example, assume that the actor module 602 receives a new formula that depends on one or more predecessor actor modules. But assume that at least one of these predecessor actor modules has not yet been created by the distributed runtime environment 114. In response, the graph management module 612 can interact with the A/D module 402 of FIG. 4 to activate one or more new actor modules.

In yet another scenario, the user may delete a formula or value that is associated with the particular actor module 602. This action does not necessarily cause the distributed runtime environment 114 to delete the actor module 602 itself. But, in response to the deletion of a formula, the graph management module 612 can send a message to any former predecessor actor modules, to inform those predecessor actor modules that it no longer depends on them. Similarly, the graph management module 612 can send a message to any former successor actor modules, to inform those successor actor modules that they should no longer wait to receive a value from the particular actor module 602. The graph management module 612 may also receive similar messages from former predecessor and/or successor actor modules. For example, a former predecessor actor module or successor module can inform the particular actor module 602 that it no longer stores a value or formula.

According to another scenario, a user may change the value of at least one actor module that will affect an entire chain of dependent actor modules, including the particular actor module 602. In certain cases, there is a risk that the chain of recalculation may create an undesirable loop, where the value of an individual actor module is recalculated two or more times (when it only should be recalculated once). To address this situation, the graph management module 612 can perform processing to ensure that the value of the actor module 602 is not updated more than once. Other actor modules perform the same function.

For example, the graph management module 612 can perform a recalculation operation for the particular actor module 602 by retrieving the values that are needed to perform the recalculation, e.g., from the particular actor module's predecessor actor module(s), if any. Upon retrieving a value from each predecessor actor module, record-keeping functionality in the cloud-side application module 122 stores the address of that predecessor actor module in a list. Then, when an instruction is given to the particular actor module 602 to recalculate its formula, the graph management module 612 receives the list and stores it in a data store 618. The graph management module 612 then consults the list to determine if the particular actor module's own address is present in the list. If this is the case, the graph management module 612 throws an exception, indicating that a circular reference has been encountered. The graph management module 612 can then invoke any kind of application-specific error processing operation(s).

For example, consider a formula associated with an actor module having an address A4 (referred to below as “actor module A4), which contains the formula “=sum(A1:A4).” That formula states that the value of the actor module A4 corresponds to the sum of values in the actors modules having addresses A1, A2, A3, and A4. The formula is circular insofar as the value of the actor module A4 depends, in part, on the value associated with the actor module A4. The particular actor module 602 can retrieve a list of its predecessor actor modules (from which values have been retrieved), just prior to performing its recalculation. It will find its own address on the list, and therefore throw an exception.

The actor module 602 depicted in FIG. 6 may perform yet other operations. The functions set forth above were described by way of illustration, not limitation. For example, actor module 602 can include a state storage module (not shown) that controls the manner in which the state associated with the actor module 602 is preserved in a backing store (if it is preserved at all). For example, the state storage module can specify the frequency at which a checkpoint for the state is created in the backing store. The distributed runtime environment 114 may consult the state of the actor module 602 when that actor module is reconstituted, assuming that the actor module 602 is deactivated and then later reactivated for any reason. Note that, in this implementation, the distributed runtime environment 114 delegates the state-storing functionality to the application code, rather than its background services.

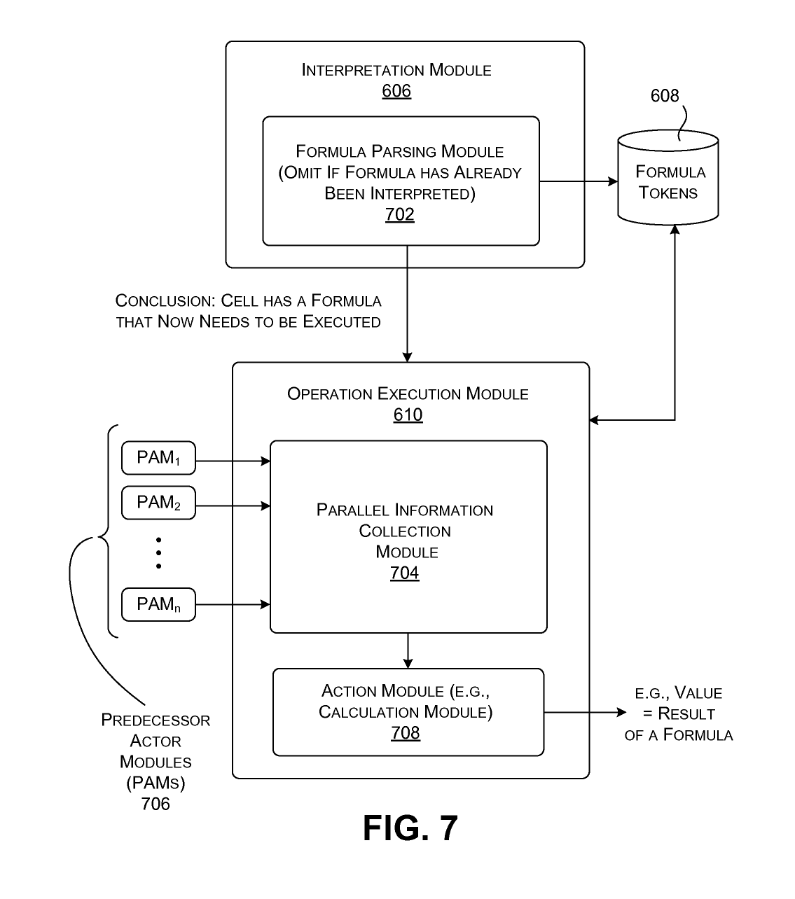

FIG. 7 provides further illustrative detail regarding one manner in which the interpretation module 606 and the operation execution module 610 process a formula that has been entered into the actor module 602 under consideration (of FIG. 6), e.g., via that actor module's UI interaction unit. As previously described, the interpretation module 606 may use a formula parsing module 702 (e.g., a recursive-descent parser) to generate formula tokens that describe the components of the formula. A data store 608 stores the formula tokens. The interpretation module 606, however, will refrain from re-parsing the formula if it has already been interpreted and it has not changed since last interpretation.

The operation execution module 610 may execute the formula in two follow-up stages. In a first stage, a parallel information collection module 704 (henceforth, simply “collection module” 704) may send requests to the predecessor actor modules 706 identified in the formula, if any. These predecessor actor modules 706, being independent entities, then work on delivering responses to the requests in parallel. The collection module 704 may therefore receive responses from these predecessor actor modules 706 in parallel. The response may provide input values for use in the formula to be computed, or may provide other results that will affect the computation of the formula. For example, instead of a numeric value, a predecessor actor module can be tasked with responsibility of making a binary decision, and the response that it provides indicates the outcome of that binary decision.

More specifically, in one case, a formula under consideration may explicitly name the individual predecessor actor modules on which it depends, e.g., by specifying the actors modules A1, A2, and A3 in FIG. 1. Alternatively, or in addition, a formula may specify a range of actor modules on which it depends, e.g., by specifying that it depends on the values provided by actor modules A1 through A100, etc.

In the above-described manner of operation, the collection module 704 uses a “pull” strategy to explicitly request input information items from the predecessor actor modules 706. But in another case, the collection module 704 can use a “push” strategy to receive the input information items, e.g., by waiting until the predecessor actor modules 706 provide the input information items on their own accord (e.g., without having received requests from the particular actor module 602).

An action module 708 executes the formula based on the responses received from the predecessor actor modules 706. In one case, the action module 708 may express the result of this computation as a numeric output value. However, the output result can also be expressed in other forms, depending on the nature of the operation that has been performed.

In one case, the collection module 704 can implement its parallel manner of operation by invoking appropriate parallel-capable method functions provided by the .NET 4.5 programming framework, provided by Microsoft Corporation of Redmond, Wash.

FIG. 8 shows another function that may be performed by the operation execution module 610. In this case, an end user may enter an input information item into the actor module 602 (via a corresponding UI interaction module, or via an automated script, etc.) that identifies an aggregate item 802. The aggregate item 802 may correspond to a body of information (e.g., a file) that provides multiple entry items (e.g., values). Any data store(s) 804 may store the aggregate item. For example, the data store(s) 804 may be implemented by a remote cloud storage site, or a local storage site (that is, “local” with respect to the end user), and/or a combination thereof. The end user may identify the aggregate item 802 in the input information item using any application-specific syntax. For example, the end user may identify any one or more of: the name of the file associated with the aggregate item 802, the storage location of the aggregate item 802, the type of file associated with the aggregate item 802, and so on. The interpretation module 606 then detects the fact that the received information item is referring to the aggregate item 802, and forwards its interpretation to the operation execution module 610.

In response to the interpretation, the operation execution module 610 uses a loading module 806 to load the aggregate item 802 into the particular actor module 602, whereupon the actor module 602 represents the aggregate item 802 as a single entity (which nonetheless has plural parts). More specifically, the loading module 806 can parse the aggregate item 802 to identify its constituent entry items. The loading module 806 can use different techniques to perform this parsing, depending on the format in which the aggregate item 802 expresses its entry items. One such format, for example, is the comma-separated value (CSV) format. The loading module 806 can automatically detect the type of format that is being used by the aggregate item 802, and/or rely on the user to manually specify that format as part of the input information item.

An optional value generation module 808 can generate a value to be displayed by the UI presentation 116, associated with the actor module 602 under consideration. For example, the value generation module 808 can count the number of entry items in the aggregate item 802, and then display that number in the UI interaction unit (e.g., the cell) associated with the actor module 602.

As a result of the above-described operation, the actor module 602 may be considered as a super cell, insofar as it appears as a single cell from the standpoint of the user, but actually represents a plurality of individual entry items. In another implementation, rather than create a super cell, the operation execution module 610 can provide instructions that cause the distributed runtime environment 114 to create plural new actor modules for storing the plural respective entry items in the aggregate item 802.

In FIG. 9, assume that the user alternatively makes reference to a particular entry item (or items) within another aggregate item 902 that has been previously loaded into, and associated with, another actor module 904. Again, the user may perform this task using any application-specific syntax, such as by specifying the address of the actor module 904 which stores the aggregate item 902, and the location(s) of the desired entry item(s) within the aggregate item 902. For example, the user may provide a multi-valued key which identifies the location of an entry item within the aggregate item 902, e.g., by presenting row and column indices for a two-dimensional grid-type organization of entry items, etc.

If it is successful in interpreting the user's input, the interpretation module 606 notifies the operation execution module 610 that the user is attempting to extract one or more entry items from the aggregate item 902. The operation execution module 610 may then deploy a value extraction module 906 to extract the desired entry item(s) from the identified actor module 904. The operation execution module 610 may apply one or more other computation modules 908 to perform additional application-specific processing. For example, a formula may instruct the operation execution module 610 to extract a value from the actor module 904 and then perform a computation on that extracted value; the other computation modules 908 may perform the appropriate follow-up computations defined by such a formula.

So far, this subsection has described different functions that may be performed by one type of actor module, namely, the type of actor module that encapsulates the behavior and state of an individual UI interaction unit (e.g., an individual cell) within a spreadsheet application or a spreadsheet-like application. The cloud-side application module 122, however, may also host other actor module types. For example, FIG. 1 indicates that the distributed runtime environment 114 also creates a directory actor module 120. The distributed runtime environment 114 produces the directory actor module 120 by producing an in-memory instantiation of a directory actor module type.

More specifically, in one implementation, as part of its initialization process, the client-side application module 110 is given a reference to the directory actor module 120. If a directory actor module 120 for the client-side application module 110 already exists, the client-side application module 110 is given a reference to that existing directory actor module 120. If it does not exist, the cloud-side application module 122 creates a new directory actor module 120 using the resources of the distributed runtime system 114. The directory actor module 120 contains a list of all other actor modules in the cloud-side application module 122, at any given time. Thus, for a blank spreadsheet, the directory actor module 120 will initially contain an empty list.

As the user enters information into the client-side application module 110, the distributed runtime environment 114 will add actor modules to the cloud-side application module 122. Correspondingly, the directory actor module 120 will add entries that identify the newly added active actor modules. For example, if the user creates the actor module A1 first, the distributed runtime environment 114 may assign a reference item of 0 to this actor module, since it is the first actor module to be created (other than the directory actor module 120 itself). The directory actor module 120 will then be updated to identify the existence of actor module A1, e.g., by specifying its reference item of 0.

The directory actor module 120 can optionally also perform other functions. For example, the directory actor module 120 can identify changes made to any UI interaction unit. A change made to a UI interaction unit may trigger the actor modules that are affected by the change to update their respective values.

A.5. Illustrative Applications

This remaining subsection describes various applications of the environment 102 shown in FIG. 1. It will be appreciated that these applications are described in the spirit of illustration, not limitation; many other types of applications are possible.

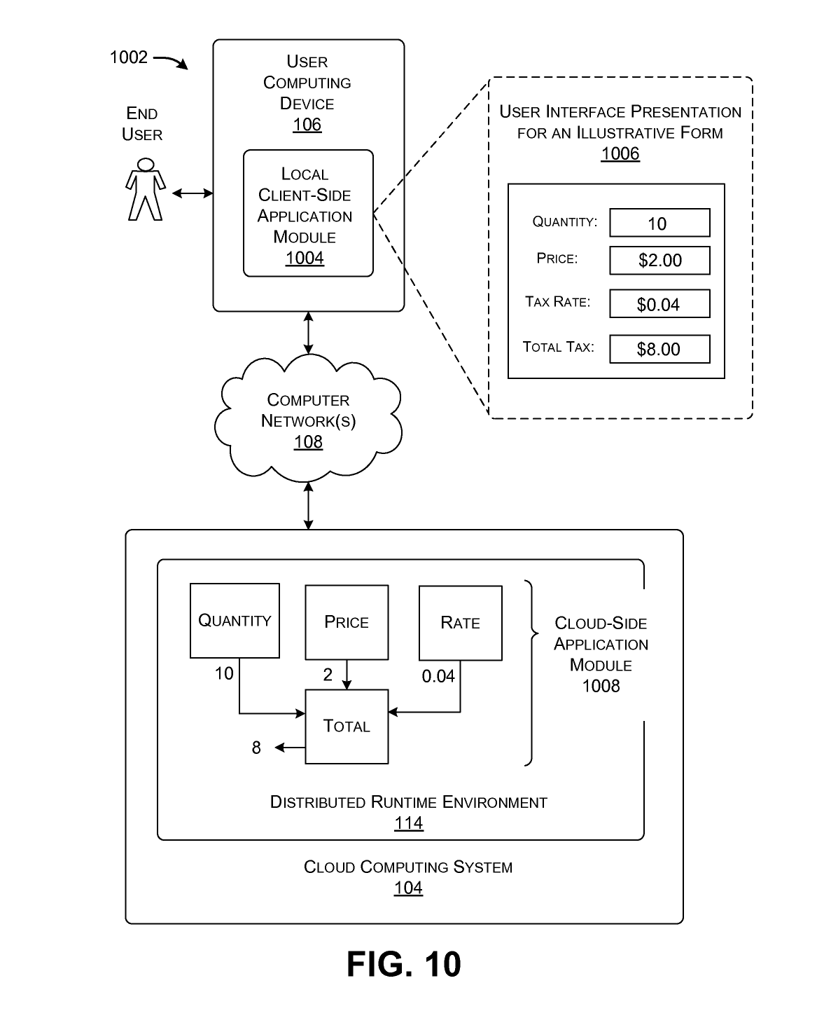

Starting with FIG. 10, this figure describes an environment 1002 in which the application corresponds to a forms-based application in which the user enters values into the cells of a form. More specifically, the environment 1002 provides a client-side application module 1004 which provides a UI presentation 1006. That UI presentation 1006, in turn, may include one or more input fields (e.g., input boxes or entry units) for receiving input information items from the user. The UI presentation 1006 can also include one or more output fields (e.g., output boxes) for displaying output information items generated by the forms-based application. In the terminology described above, each input or output field corresponds to a UI interaction unit.

The distributed runtime environment 114 responds to the user's input actions by creating actor modules associated with the UI interaction units that have been invoked. For example, assume that the form includes user input boxes for receiving input values for the categories of “quantity,” “price,” and “tax rate.” Further assume that the form includes a single output box for receiving a “total tax” amount, which is a value computed by the cloud-side application module by multiplying values for quantity, price, and tax rate together. In one non-limiting application, the distributed runtime environment 114 may create actor modules for all four of the above-described fields when the user enters a first value into any of the input fields. But this invocation strategy is application-specific in nature; other implementations can vary the timing at which the distributed runtime environment 114 invokes each actor module. In any event, collectively, the group of actor modules (for quantity, price, rate, and total tax) represents the cloud-based application module 1008 at a particular point in time.

In the above case, the actor modules for the four fields (quantity, price, rate, and total tax) perform fixed respective functions, rather than, as in the case of a general spreadsheet application, open-ended user-defined functions. For example, the actor module for the “total tax” output box executes the fixed formula that involves the multiplication of quantity, price, and tax rate. Accordingly, the distributed runtime environment 114 can allocate an actor module to each UI interaction unit in the form which is specifically tailored to perform its fixed respective function. For example, the actor module for the “total tax” output box is configured to execute the fixed formula, but other actors modules (associated with the input boxes) are not. To support this mode of operation, the distributed runtime system 114 can instantiate the actor modules based on respective code components that define different types of actor modules.

In another implementation, the distributed runtime environment 114 can use the general-purpose functionality described above with respect to FIG. 6 to implement all four actor modules in FIG. 10. But the distributed runtime environment 114 can also automatically configure each actor module in a specific manner upon its activation, such that it performs its desired fixed function in the context of the form that has been invoked. For example, the distributed runtime environment 114 can automatically load the desired formula for the “total tax” output box, which will ensure that the corresponding actor module performs the desired calculation in the context of the form with which the user is interacting.

As a general point, in any of the form-based scenarios described herein, a form developer may create a form that uses a spreadsheet-like syntax when referring to its different fields, and when defining the functions of those fields, etc. For example, the spreadsheet-like format may correspond to, or resemble, the syntax used in commercially-available spreadsheet programs, such as the EXCEL program provided by Microsoft Corporation of Redmond, Wash. For instance, a developer may create a form that refers to a field (e.g., a “cell”) by specifying its cell address. A developer may also associate a formula with that cell. The use of a familiar syntax may facilitate the developer's creation of a form, e.g., because the developer is not asked to learn a new syntax. Further note that the term “developer” is used liberally herein; for instance, a developer can also include any end user who creates a form for his or her own consumption, and/or for the consumption of others.

However, note that the application that is created in the above-described manner otherwise functions in a different manner than a conventional spreadsheet. For example, in one manner of operation, a developer may create the form of FIG. 10 by creating a client-side application that associates each of the above-described cells with a respective cell address. The client-side application may also associate a formula with the “total tax” cell, e.g., which specifies that the output value of that cell is the product of the values in cells A1, A2, and A3 (corresponding to the “quantity,” “price,” and “tax rate” fields). Upon initializing the client-side application module, the client-side application module may notify the cloud-side functionality of the cells associated with the form. (The cloud-side functionality corresponds to the cloud-side application module that is the counterpart to the client-side application module, along with the underlying distributed runtime system 114.) The cloud-side functionality will then instantiate actor modules in an actor model framework which correspond to the cells defined by the form. The cloud-side functionality may perform these operations in the same manner described above, e.g., with respect to the description of FIG. 6.

Note, however, that the above initialization procedure represents only one solution among others. For instance, in another implementation, the cloud-side application module can already store knowledge regarding the cells that are associated with a particular form under consideration. As such, this implementation may not entail a transfer of cell-defining information from the client-side application module to the cloud-side functionality.

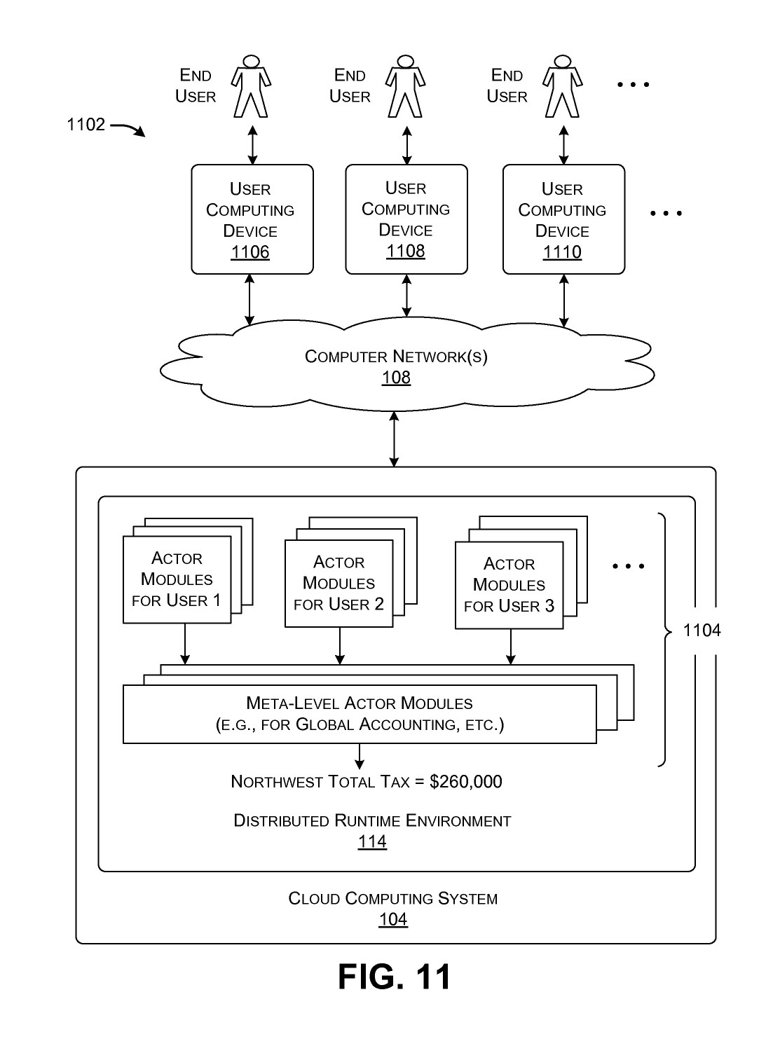

Advancing to FIG. 11, this figure shows an environment 1102 in which plural end users interact with the same cloud-based application 1104, via plural respective user computing devices (1106, 1108, 1110, . . . ). The plural respective user computing devices (1106, 1108, 1110, . . . ) may also implement plural respective client-side application modules (not shown in FIG. 11).

Consider the specific case in which each user is associated with a particular geographic region, such as a particular part of the United States. Further assume that each user interacts with the same kind of forms-based application described above with respect to FIG. 10. That is, each user, who operates in a different region of the country, enters quantity, price, and tax rate information that applies to his or her particular region of the country. The cloud-based application module 1104 performs the same function above to provide the “total tax” information to each respective user.

In addition, the cloud-based application module 1104 may extract information across different user-specific forms, and then aggregate that information to provide higher-level summary information. For example, the cloud-based application module 1104 can sum up all of the “total tax” results for users who are based in the northwest region of the United States, and display that sum to those users.

To implement the above functions, the distributed runtime environment 114 can devote a collection of user-specific actor modules to each user. Those user-specific actor modules may perform the same functions described above for the scenario of FIG. 10. In addition, the distributed runtime environment 114 can use one or more meta-level actor modules to collect input values across different user-specific actor modules, and then provide one or more meta-level output results for consumption by those users. The details of these calculations are application-specific in nature, and will differ for different applications. Applications may differ at least in regard to: the particular manner in which the meta-level actor modules are coupled to the user-specific actor modules; the specific manner in which the meta-level actor modules are coupled to each other; the specific calculations performed by the user-specific and meta-level actor modules, and so on.

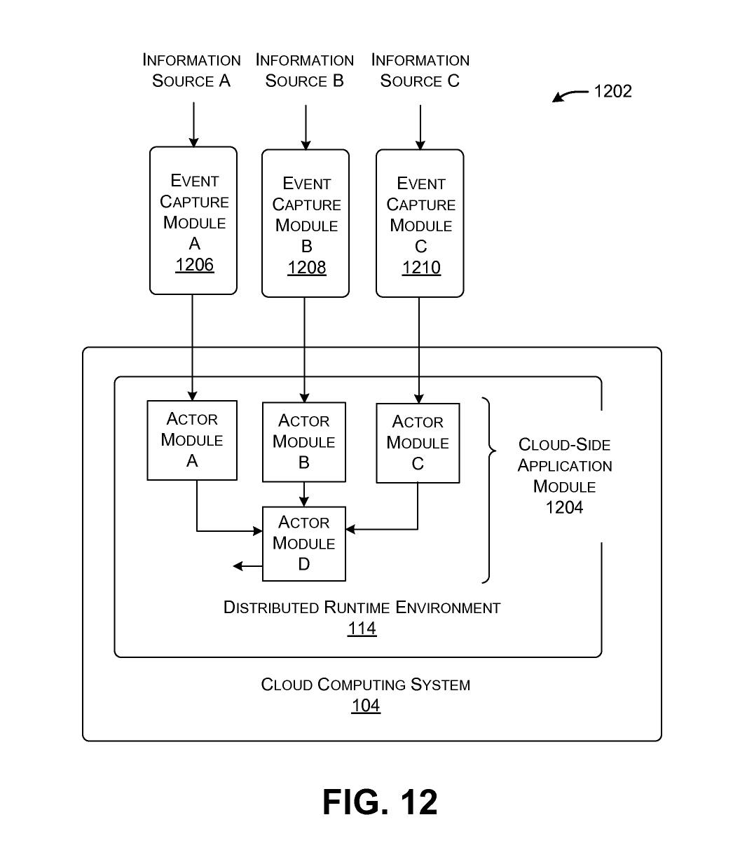

FIG. 12 shows an environment 1202 in which the cloud-side application module 1204 receives input information items from three external information sources. For example, an event capture module A 1206 may receive input information from a first information source, an event capture module B 1208 may receive input information from a second information source, and an event capture module C 1210 may receive input information from a third information source. Actor modules A, B, and C, receive the input information supplied by these event capture modules (1206, 1208, 1210). The use of three information feeds is merely representative; other cloud-side application modules can receive input information items from any number of information sources, and can consume that information in any manner by their actor modules.

In some cases, at least some information sources may provide a real-time stream of input information items. For example, the event capture module A 1206 may receive a dynamically changing stream of stock prices. In addition, or alternatively, at least some information sources may provide access to historical information, or other slowly-varying information.

In other cases, the different streams of input information items may present different subsets of information items that originate from the same source, or related sources. For example, consider a source which provides measurements pertaining to a geographical region, such as temperature readings corresponding to a particular country. Different event capture modules can capture measurement information associated with different sub-regions within the overall region; further, different actor modules may be assigned the task of processing the measurement information for those sub-regions. The sub-regions may correspond to two-dimensional regions or three-dimensional volumes, or some other partitions associated with the general map region.

In some applications, the processing of real-time streams of information items may impose a large processing burden on the computing system 104. The computing system 104 is able to handle this large processing load due to its reliance on the collective resources of multiple server computing devices, together with its parallel-processing characteristics described above, e.g., explained with reference to FIG. 7.

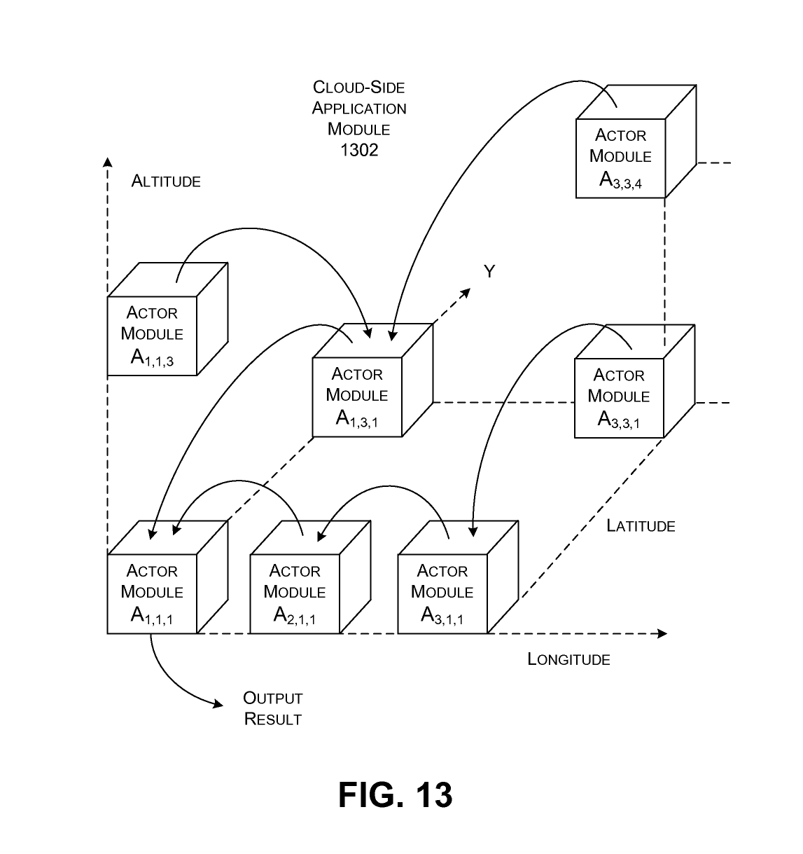

FIG. 13 shows an example in which a cloud-side application module 1302 hosts, at any given time, plural actor modules within an actor space that has three dimensions. More generally, the cloud-side application module 1302 can activate and deactivate actor modules within an actor space having any number of dimensions. Each such actor module may receive input information items of any nature, e.g., as manually supplied by the user, and/or as automatically supplied by any capture module.

In one application, the cloud-side application module 1302 can use a three-dimensional actor space to model the behavior of physical processes which take place in a physical three-dimensional space. For example, again consider the map-related application introduced above with respect to FIG. 12. A general map region may be broken up into plural three-dimensional volumes. Different actor modules can be associated with the respective physical three-dimensional volumes. Those actor modules can then process measurement information associated with the volumes, in any application-specific manner.

As a final comment to this subsection, the preceding examples were all predicated on the assumption that the output information items generated by the actor modules are provided to the user in the form of UI interaction units, e.g., as output values presented in spreadsheet cells. But in other cases, at least some output information items can be applied to serve other purposes. For example, the environment 102 of FIG. 1 can associate actor modules with respective devices of any nature. The actor modules can receive input information items from these devices, e.g., which describe the respective states of these devices. In addition, the actor modules can supply output information items to these devices. The output information items can be used to control these devices in any manner. For example, an actor module can be used to turn on a remote video camera, lock a door, start a kitchen appliance, and so on.

In another case, a cloud-side application module can integrate with a social network application. In that context, an actor module can be used to update a user's profile, send a message, etc.

B. Illustrative Processes

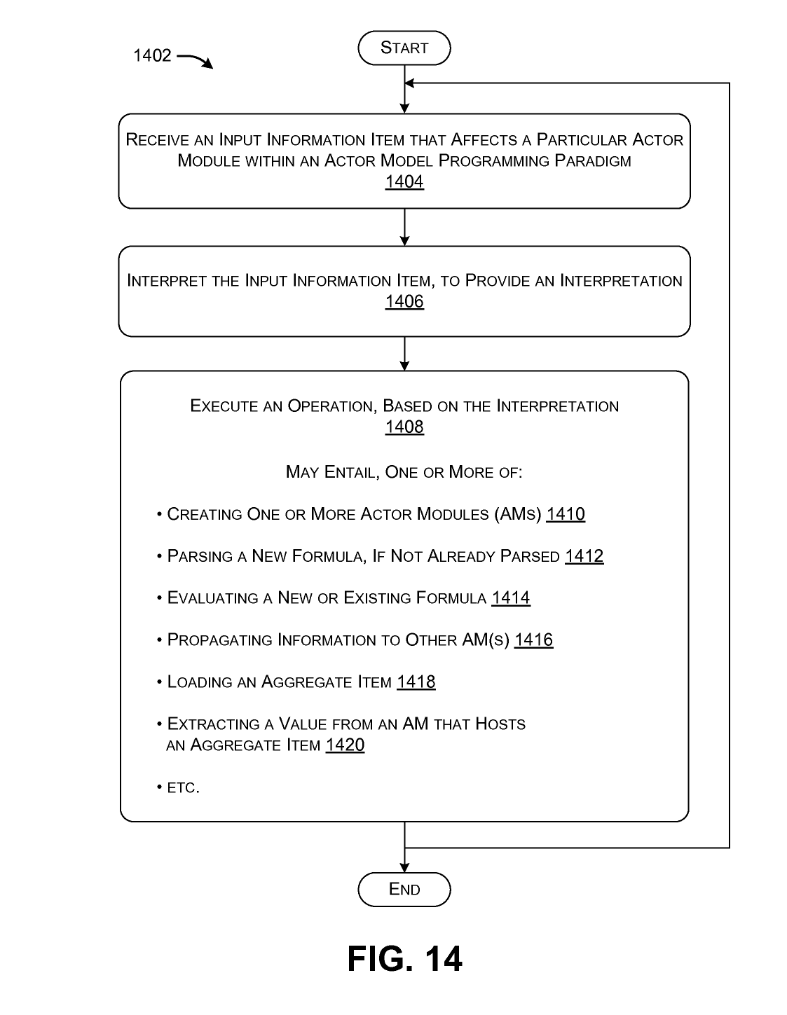

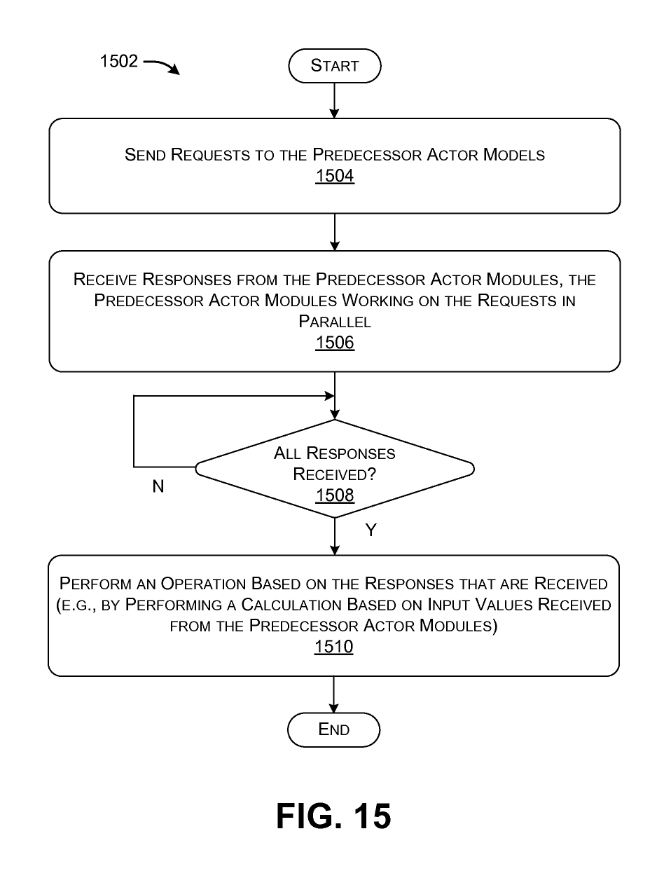

FIGS. 14 and 15 show processes that explain the operation of the environment 102 of Section A in flowchart form. Since the principles underlying the operation of the environment 102 have already been described in Section A, certain operations will be addressed in summary fashion in this section.

Starting with FIG. 14, this figure shows a process 1402 which represents an overview of one manner of operation of the environment 102 of FIG. 1. More specifically, FIG. 14 depicts the operation of the environment 102 from the “perspective” of an individual actor module, such as the particular actor module 602 shown in FIG. 6. In block 1404, the particular actor module 602 receives an input information item. That input information item may represent information that is entered by an end user, supplied by an external information source, or supplied in any other manner. In block 1406, the particular actor module 602 interprets the nature of the information item that has been supplied, e.g., to determine whether it is a new formula, an updated value, an identification of an aggregate item, a reference to an entry item within a previously-loaded aggregate item, and so on. In block 1408, the particular actor module 602 performs one or more operations based on the interpretation supplied in block 1406.

For example, depending on the nature of the input information item that is received, in block 1410, the particular actor module 602 may send instructions that cause the distributed runtime environment 114 to create one or more new actor modules. For example, as explained above, the user may input a formula into the particular actor module 602 that makes reference to at least one predecessor actor module. If that predecessor actor module does not yet exist, the particular actor module 602 can send instructions which cause it to be created.

In block 1412, the particular actor module 602 parses a new formula, that is, if the information item that has been received corresponds to a new formula that has not yet been parsed. In block 1414, the particular actor module 602 can evaluate a new or existing formula based on formula tokens that have been created in the parsing operation. In block 1416, the particular actor module 602 can interact with other actor modules in various circumstances, such as to notify predecessor actor modules that the particular actor module 602 depends on them, and to receive input information items from those predecessor actor modules. Similarly, the particular actor module 602 can receive information from successor actor modules, informing the particular actor module 602 that these successor actor modules depend on it. The particular actor module 602 can also propagate output results to these successor actor modules. In addition, the particular actor module 602 can notify appropriate predecessor actor modules when its contents have been deleted; the particular actor module 602 can similarly receive notifications from successor modules that serve to inform the particular actor module 602 that they no longer depend on it.

In block 1418, in the case in which the input information item identifies an aggregate item, the particular actor module 602 can load and parse the aggregate item. In block 1420, in the case in which the input information item identifies a specific entry item that is included in an aggregate item that has already been loaded, the particular actor module 602 can extract that entry item from the identified super cell.

The particular actor module 602 may perform yet other functions not specifically called out in FIG. 14. For example, the particular actor module 602 can store its state in a backing store in any application-specific manner specified by the application developer.

Note that FIG. 14 was described for the open-ended case in which a user is free to enter any type of information item into an UI interaction unit, including a numeric value, a formula, a reference to an aggregate item, and so on. In other cases, an application may place one or more constraints on the type of information item that the user may supply to a UI interaction unit, and/or the type of information item that the application may output to a UI interaction unit. This qualification may apply, for instance, to the types of form-based applications described above, where the functions associated with individual cells are already established, by default. In those cases, the interpretation and execution operations in the process 1402 may be correspondingly restricted.

FIG. 15 shows a process 1502 that represents one manner by which the operation execution module 610 (of the particular actor module 602 shown in FIG. 6) may perform a parallel computation. For example, assume that the operation execution module 610 performs the process 1502 in the context of evaluating a formula that relies on input information items supplied by two or more predecessor actor modules. In block 1504, the operation execution module 610 can send requests to the predecessor actor modules, instructing them to provide responses to the particular actor module 602. The predecessor actor modules respond to these requests by supplying their responses in parallel. In block 1506, the operation execution module 610 receives the responses. In block 1508, the operation execution module 610 determines whether it has received all of the responses from the predecessor actor modules. In block 1510, once all of the responses have been received, the operation execution module 610 performs an operation based on the responses. For example, the operation execution module 610 may execute a formula based on input values received from the predecessor actor modules. In an alternative mode of operation, the operation execution module 610 can use a push strategy to receive information from the predecessor actor modules, e.g., without sending explicit requests to these modules.

To summarize the explanations in Sections A and B, according to a first aspect, a computing system is provided that includes plural computing devices, provided by one or more data centers. The plural computing devices have computing resources that host plural actor modules. The plural actor modules, in turn, correspond to activated instantiations of at least one actor module type in an actor model programming paradigm. Further, the plural actor modules are coupled together, via an exchange of messages, according to a defined graph relationship. At least a subset of the plural actor modules have counterpart user interface (UI) interaction units, presented via a client-side application module, through which an end user may interact with the subset of the plural actor modules.

According to a second aspect, which can be combined with any other aspect(s) set forth herein, the counterpart UI interaction units correspond to cells in a spreadsheet presented by the client-side application module.

According to a third aspect, which can be combined with any other aspect(s) set forth herein, the counterpart UI interaction units correspond to entry units within a fillable form presented by the client-side application module.

According to a fourth aspect, which can be combined with any other aspect(s) set forth herein, the counterpart UI interaction units correspond to entry units through which plural end users enter information.

According to a fifth aspect, which can be combined with any other aspect(s) set forth herein, at least one particular actor module includes an interpretation module and an operation execution module. The interpretation module is configured to interpret an input information item entered by the end user via a corresponding UI interaction unit, to provide an interpretation. The operation execution module is configured to execute an operation, based on the interpretation.

According to a sixth aspect, which can be combined with any other aspect(s) set forth herein, the above-mentioned interpretation module is configured to determine whether or not an input information item corresponds to a new formula. When the input information item corresponds to a new formula, the interpretation module parses the formula to produce interpreted formula information.

According to a seventh aspect, which can be combined with any other aspect(s) set forth herein, the above-mentioned interpretation module is configured to determine whether or not an input information item identifies an aggregate item, the aggregate item being associated with a plurality of entry items. When the input information item identifies an aggregate item, the above-mentioned operation execution module is configured to parse the aggregate item and associate the plurality of entry items with the particular actor module.

According to an eighth aspect, which can be combined with any other aspect(s) set forth herein, another actor module stores an aggregate item, the aggregate item being associated with a plurality of entry items. Further, the above-mentioned interpretation module is configured to determine whether or not an input information item identifies a particular entry item associated with the aggregate item, associated with the other actor module. When the input information item identifies the entry item, the above-mentioned operation execution module is configured to extract that entry item from the other actor module.

According to a ninth aspect, which can be combined with any other aspect(s) set forth herein, at least one particular actor module includes an operation execution module that is configured to execute a formula associated with a particular actor module, to produce an output information item for the particular actor module.

According to a tenth aspect, which can be combined with any other aspect(s) set forth herein, the particular actor module (mentioned with respect to the ninth aspect) executes the formula based on input information items provided by plural predecessor actor modules. Further, the operation execution module of the particular actor module is configured to send requests to the plural predecessor actor modules, and, in parallel, to receive responses from the plural predecessor actors modules prior to executing the formula.

According to an eleventh aspect, which can be combined with any other aspect(s) set forth herein, at least one successor module is dependent on an output information item produced by a particular actor module. The particular actor module further includes a graph management module that is configured to notify the successor actor module(s) of the output information item produced by the particular actor module.

According to an eleventh aspect, which can be combined with any other aspect(s) set forth herein, at least one actor module is configured to automatically receive input information items from an external information source.

According to a thirteenth aspect, which can be combined with any other aspect(s) set forth herein, plural actor modules may be communicatively coupled together within an actor space having three or more dimensions.

According to a fourteenth aspect, which can be combined with any other aspect(s) set forth herein, the client-side application module (mentioned with respect to the first aspect) corresponds to a spreadsheet application having local functionality for performing spreadsheet functions; it also has an interface module for interacting with the computing system.

According to a fifteenth aspect, which can be combined with any other aspect(s) set forth herein, at least one actor module provides an output information item that is used to control a device.

According to a sixteenth aspect, which can be combined with any other aspect(s) set forth herein, a method if provided, performed by a computing system that includes a plurality of computing devices, for executing an application. The method includes an operation of receiving an input information item that pertains to a particular actor module. That particular actor module corresponds to one of plural actor modules that operate within an actor model program programming paradigm. Further, the particular actor module is communicatively coupled to plural predecessor actor modules. The method further includes interpreting the input information item, to provide an interpretation, and executing an operation, based on the interpretation. The executing operation, in turn, includes, in parallel, receiving responses from the plural predecessor actor modules, and performing the operation based on the responses that are received.

According to a seventeenth aspect, which can be combined with any other aspect(s) set forth herein, at least a subset of the plural actor modules (set forth with respect to the method of sixteenth aspect) have counterpart user interface (UI) interaction units, presented via a client-side application module, through which an end user may interact with the subset of the plural actor modules.

According to an eighteenth aspect, which can be combined with any other aspect(s) set forth herein, the counterpart UI interaction units (identified with respect to the seventeenth aspect) correspond to cells in a spreadsheet presented by the client-side application module.

According to a nineteenth aspect, which can be combined with any other aspect(s) set forth herein, the responses from the plural predecessor actor modules (identified with respect to the sixteenth aspect) provide input information items, and the operation entails executing a formula based on the input information items.

According to a twentieth aspect, which can be combined with any other aspect(s) set forth herein, a computer readable storage medium for storing computer readable instructions is described herein. The computer readable instructions implement a cloud-based application module when executed by one or more processing devices. The computer readable instructions include logic configured to implement plural actor modules corresponding to activated instantiations of at least one actor module type in an actor model programming paradigm. The plural actor modules are coupled together, via an exchange of messages, according to a defined graph relationship. Further, a least a subset of the plural actor modules have counterpart user interface (UI) interaction units, presented via a client-side application module, through which an end user may interact with the subset of the plural actor modules.

According to yet another aspect, one or more computing devices may be provided that has respective means for performing any combination of the functions set forth with respect to the first through twentieth aspects.

C. Representative Computing Functionality

FIG. 16 shows computing functionality 1602 that can be used to implement any aspect of the environment set forth in the above-described figures. For instance, the type of computing functionality 1602 shown in FIG. 16 can be used to implement any server computing device within the computing system 104, any user computing device (such as the user computing device 106 of FIG. 1), and so on. In all cases, the computing functionality 1602 represents one or more physical and tangible processing mechanisms.

The computing functionality 1602 can include one or more processing devices 1604, such as one or more central processing units (CPUs), and/or one or more graphical processing units (GPUs), and so on.

The computing functionality 1602 can also include any storage resources 1606 for storing any kind of information, such as code, settings, data, etc. Without limitation, for instance, the storage resources 1606 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 1602. The computing functionality 1602 may perform any of the functions described above when the processing devices 1604 carry out instructions stored in any storage resource or combination of storage resources.

As to terminology, any of the storage resources 1606, or any combination of the storage resources 1606, may be regarded as a computer readable medium. In many cases, a computer readable medium represents some form of physical and tangible entity. The term computer readable medium also encompasses propagated signals, e.g., transmitted or received via physical conduit and/or air or other wireless medium, etc. However, the specific terms “computer readable storage medium” and “computer readable medium device” expressly exclude propagated signals per se, while including all other forms of computer readable media.

The computing functionality 1602 also includes one or more drive mechanisms 1608 for interacting with any storage resource, such as a hard disk drive mechanism, an optical disk drive mechanism, and so on.

The computing functionality 1602 also includes an input/output module 1610 for receiving various inputs (via input devices 1612), and for providing various outputs (via output devices 1614). Illustrative input devices include a keyboard device, a mouse input device, a touchscreen input device, a digitizing pad, one or more video cameras, one or more depth cameras, a free space gesture recognition mechanism, one or more microphones, a voice recognition mechanism, any movement detection mechanisms (e.g., accelerometers, gyroscopes, etc.), and so on. One particular output mechanism may include a presentation device 1616 and an associated graphical user interface (GUI) 1618. Other output devices include a printer, a model-generating mechanism, a tactile output mechanism, an archival mechanism (for storing output information), and so on. The computing functionality 1602 can also include one or more network interfaces 1620 for exchanging data with other devices via one or more communication conduits 1622. One or more communication buses 1624 communicatively couple the above-described components together.

The communication conduit(s) 1622 can be implemented in any manner, e.g., by a local area network, a wide area network (e.g., the Internet), point-to-point connections, etc., or any combination thereof. The communication conduit(s) 1622 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 1602 can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

In closing, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
plural computing devices, provided by one or more data centers,
the plural computing devices having computing resources that host plural actor modules,
the plural actor modules corresponding to activated instantiations of at least one actor module type in an actor model programming paradigm,
the plural actor modules being coupled together, via an exchange of messages, according to a defined graph relationship, and
at least a subset of the plural actor modules having counterpart user interface (UI) interaction units, presented via a client-side application module, through which an end user may interact with the subset of the plural actor modules.

2. The computing system of claim 1, wherein the counterpart UI interaction units correspond to cells in a spreadsheet presented by the client-side application module.

3. The computing system of claim 1, wherein the counterpart UI interaction units correspond to entry units within a fillable form presented by the client-side application module.

4. The computing system of claim 1, the counterpart UI interaction units correspond to entry units through which plural end users enter information.

5. The computing system of claim 1, wherein at least one particular actor module includes:
an interpretation module configured to interpret an input information item entered by the end user via a corresponding UI interaction unit, to provide an interpretation; and
an operation execution module configured to execute an operation, based on the interpretation.

6. The computing system of claim 5,
wherein the interpretation module is configured to determine whether or not the input information item corresponds to a new formula, and,
when the input information item corresponds to a new formula, parse the formula to produce interpreted formula information.

7. The computing system of claim 5,
wherein the interpretation module is configured to determine whether or not the input information item identifies an aggregate item, the aggregate item being associated with a plurality of entry items, and,
when the input information item identifies an aggregate item, the operation execution module is configured to parse the aggregate item and associate the plurality of entry items with the particular actor module.

8. The computing system of claim 5,
wherein another actor module stores an aggregate item, the aggregate item being associated with a plurality of entry items,
wherein the interpretation module is configured to determine whether or not the input information item identifies a particular entry item associated with the aggregate item, associated with the other actor module, and
when the input information item identifies the entry item, the operation execution module is configured to extract that entry item from the other actor module.

9. The computing system of claim 1,
wherein at least one particular actor module includes an operation execution module that is configured to execute a formula associated with the particular actor module, to produce an output information item for the particular actor module.

10. The computing system of claim 9,
wherein the particular actor module executes the formula based on input information items provided by plural predecessor actor modules, and
wherein the operation execution module of the particular actor module is configured to send requests to the plural predecessor actor modules, and, in parallel, to receive responses from the plural predecessor actors modules prior to executing the formula.

11. The computing system of claim 9,
wherein at least one successor module is dependent on the output information item produced by the particular actor module, and
wherein the particular actor module further includes a graph management module that is configured to notify said at least one successor actor module of the output information item produced by the particular actor module.

12. The computing system of claim 1, wherein at least one actor module is configured to automatically receive input information items from an external information source.

13. The computing system of claim 1, wherein the plural actor modules are communicatively coupled together within an actor space having three or more dimensions.

14. The computing system of claim 1, wherein the client-side application module corresponds to a spreadsheet application having local functionality for performing spreadsheet functions, and also having an interface module for interacting with the computing system.

15. The computing system of claim 1, wherein at least one actor module provides an output information item that is used to control a device.

16. A method, performed by a computing system that includes a plurality of computing devices, for executing an application, comprising:
receiving an input information item that pertains to a particular actor module,
the particular actor module corresponding to one of plural actor modules that operate within an actor model program programming paradigm, and
the particular actor module being communicatively coupled to plural predecessor actor modules;
interpreting the input information item, to provide an interpretation; and
executing an operation, based on the interpretation, involving:
in parallel, receiving responses from the plural predecessor actor modules; and
performing the operation based on the responses that are received.

17. The method of claim 16, wherein at least a subset of the plural actor modules have counterpart user interface (UI) interaction units, presented via a client-side application module, through which an end user may interact with the subset of the plural actor modules.

18. The method of claim 17, wherein the counterpart UI interaction units correspond to cells in a spreadsheet presented by the client-side application module.

19. The method of claim 16,
wherein the responses received from the plural predecessor actor modules provide input information items, and
wherein the operation entails executing a formula based on the input information items.

20. A computer readable storage medium for storing computer readable instructions, the computer readable instructions implementing a cloud-based application module when executed by one or more processing devices, the computer readable instructions comprising:
logic configured to implement plural actor modules corresponding to activated instantiations of at least one actor module type in an actor model programming paradigm,
the plural actor modules being coupled together, via an exchange of messages, according to a defined graph relationship,
at least a subset of the plural actor modules having counterpart user interface (UI) interaction units, presented via a client-side application module, through which an end user may interact with the subset of the plural actor modules.
